(19) United States
(12) Patent Application Publication
(10) Pub. No.: US 2016/0026694 A1
(43) Pub. Date: Jan. 28, 2016

(54) METHOD AND APPARATUS FOR PROVIDING SEARCH RESULT

(71) Applicant: Baidu Online Network Technology (Beijing) Co., Ltd, Beijing (CN)

(72) Inventor: Mengchen Shi, Beijing (CN)

(21) Appl. No.: 14/584,989

(22) Filed: Dec. 29, 2014

(30) Foreign Application Priority Data
Jul. 28, 2014 (CN) 201410364334.7

(51) Int. Cl. G06F 17/30; H04L 29/08

(52) U.S. Cl. CPC G06F 17/30554; G06F 17/30861; H04L 67/22

(57) ABSTRACT

The present invention proposes a method and apparatus for providing a search result, in order to improve the utilization efficiency of a search result card. The method for providing a search result card comprises: acquiring, according to a search term input by a user, at least one search result card corresponding to the search term; displaying a first side of the at least one search result card to the user; determining that the user needs to turn over a first search result card, the first search result card being a search result card selected by the user from the at least one search result card; and turning over the first search result card to display a second side of the first search result card to the user. The method can improve the utilization efficiency of the search result card and provide more information via the search result card.

### TECHNICAL FIELD

The present invention relates to the technical field of network communications, and in particular, to a method and apparatus for providing a search result.

### BACKGROUND

With the appearance of the intelligent terminal, a user may use an intelligent terminal such as a mobile phone to achieve a search. In related technologies, after the user inputs a search term using a mobile phone, a search result is displayed to the user in the form of a card. The user may view the search result by clicking on a corresponding card. With the limitation of the capacity of the search result card, a web link may be added in the search result card, and the user may enter another page by clicking on the web link, wherein more information may be recorded in the another page. For example, a merchant may link a merchant home page to a search result card, a user may enter the merchant home page by clicking on the link in the search result card so as to acquire more information about the merchant.

However, in this way, the user needs to click on the web link to jump to another page so as to acquire more information.

### SUMMARY

The present invention is intended to solve one of the technical problems in the related art at least to some extent.

For this purpose, one objective of the present invention is to propose a method for providing a search result. The method may make better use of a search result card and may acquire more information from the search result card without the need for web page jumping, thereby improving resource utilization efficiency.

Another objective of the present invention is to propose an apparatus for providing a search result.

In order to achieve the above-mentioned objectives, an embodiment from a first aspect of the present invention proposes a method for providing a search result, comprising: acquiring, according to a search term input by a user, at least one search result card corresponding to the search term, wherein each search result card comprises a first side and a second side, the first side and the second side being oppositely arranged, and the first side and/or the second side recording search results; displaying the first side of the at least one search result card to the user; determining that the user needs to turn over a first search result card, the first search result card being a search result card selected by the user from the at least one search result card; and turning over the first search result card to display the second side of the first search result card to the user.

By means of recording information on both sides of the search result card, the user may acquire more information with respect to single-side display by turning over the search result card, and therefore, the method for providing a search result proposed in the first aspect embodiment of the present invention may provide the resource utilization rate and improve user experience.

In order to achieve the above-mentioned objectives, an embodiment of a second aspect of the present invention proposes an apparatus for providing a search result, comprising: an acquisition module, for acquiring, according to a search term input by a user, at least one search result card corresponding to the search term, wherein each search result card comprises a first side and a second side, the first side and the second side being oppositely arranged, and the first side and/or the second side recording search results; a display module, for displaying the first side of the at least one search result card to the user; a determination module, for determining that the user needs to turn over a first search result card, the first search result card being a search result card selected by the user from the at least one search result card; and a turnover module, for turning over the first search result card to display the second side of the first search result card to the user.

By means of recording information on both sides of the search result card, the user may acquire more information with respect to single-side display by turning over the search result card, and therefore, the apparatus for providing a search result proposed in the second aspect embodiment of the present invention may provide the resource utilization rate and improve user experience.

In order to achieve the above-mentioned objects, a third aspect embodiment of the present invention proposes a mobile terminal, comprising: a housing, a processor, a memory, a circuit board and a power supply circuit, wherein the circuit board is mounted inside a space enclosed by the housing, and the processor and the memory are disposed on the circuit board; the power supply circuit is used for supplying power to various circuits or devices of the mobile terminal; the memory is used for storing executable program codes; and the processor operates programs corresponding to the executable program codes by reading the executable program codes stored in the memory for carrying out the following steps: acquiring, according to a search term input by a user, at least one search result card corresponding to the search term, wherein each search result card comprises a first side and a second side, the first side and the second side being oppositely arranged, and the first side and/or the second side recording search results; displaying the first side of the at least one search result card to the user; determining that the user needs to turn over a first search result card, the first search result card being a search result card selected by the user from the at least one search result card; and turning over the first search result card to display the second side of the first search result card to the user.

By means of recording information on both sides of the search result card, the user may acquire more information with respect to single-side display by turning over the search result card, and therefore, the mobile terminal proposed in the third aspect embodiment of the present invention may provide the resource utilization rate and improve user experience.

Some of the additional aspects and advantages of the present invention will be given in the description below, and some will become apparent from the following description, or can be learned by the practice of the present invention.

### BRIEF DESCRIPTION OF THE ACCOMPANYING DRAWINGS

The above-mentioned and/or additional aspects and advantages of the present invention will become apparent and easily understood from the description of the embodiments below in combination with the accompanying drawings, in which:

FIG. 1 is a schematic flowchart of a method for providing a search result proposed by one embodiment of the present invention;

FIG. 2 is a schematic flowchart of a method for providing search content proposed by another embodiment of the present invention;

FIG. 3 is a schematic diagram illustrating that a search result card displays a first side in the embodiments of the present invention;

FIG. 4 is a schematic diagram of selecting a search result card to be turned over in the embodiments of the present invention;

FIG. 5 is a schematic diagram illustrating that a search result card turns over to an intermediate state in the embodiments of the present invention;

FIG. 6 is a schematic diagram illustrating that a search result card turns over to a second side in the embodiments of the present invention;

FIG. 7 is a schematic diagram illustrating when a search result card starts to turn over from a second side in the embodiments of the present invention;

FIG. 8 is a schematic diagram illustrating when a search result card turns back from a second side to a first side in the embodiments of the present invention;

FIG. 9 is a schematic flowchart of a method for providing a search result proposed by another embodiment of the present invention;

FIG. 10 is a schematic flowchart of a method for providing a search result proposed by another embodiment of the present invention;

FIG. 11 is a structural schematic diagram of an apparatus for providing a search result proposed by another embodiment of the present invention;

FIG. 12 is a structural schematic diagram of an apparatus for providing a search result proposed by another embodiment of the present invention;

FIG. 13 is a structural schematic diagram of an apparatus for providing a search result proposed by another embodiment of the present invention; and

FIG. 14 is a structural schematic diagram of an apparatus for providing a search result proposed by another embodiment of the present invention.

### DETAILED DESCRIPTION OF THE PREFERRED EMBODIMENTS

The embodiments of the present invention will be described in detail below, and examples of the embodiments are shown in the accompanying drawings, in which the same or similar reference numerals represent the same or similar elements or elements having the same or similar functions throughout. The embodiments described below with reference to the accompanying drawings are exemplary and are merely used to explain the present invention, rather than being understood as limitations to the present invention. On the contrary, the embodiments of the present invention include all the changes, modifications and equivalents falling into the scope of the spirit and principles of the appended claims.

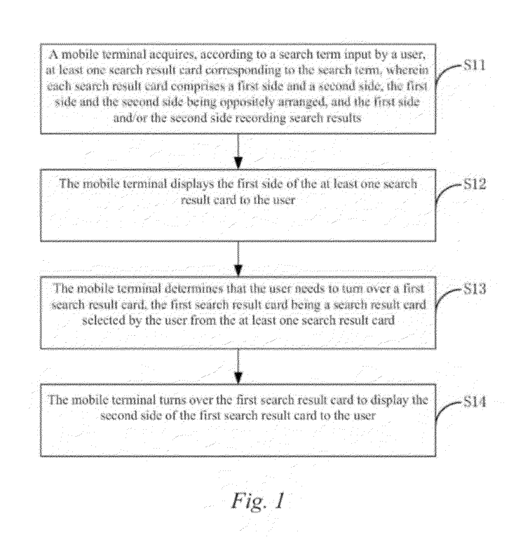

FIG. 1 is a schematic flowchart of a method for providing a search result proposed by one embodiment of the present invention, the method comprising:

S11: a mobile terminal acquires, according to a search term input by a user, at least one search result card corresponding to the search term, wherein each search result card comprises a first side and a second side, the first side and the second side being oppositely arranged, and the first side and/or the second side recording search results.

The mobile terminal may refer to a mobile phone, or a tablet computer, etc.

The mobile terminal may acquire corresponding search results from a server and display same to the user.

For example, when searching for “fresh flowers”, the mobile terminal will display a search result card containing “fresh flowers” to the user.

In the related art, each search result is displayed on a single side in the form of a card in a mobile terminal, and the user may click to enter a selected search result card when needing to view more content.

In this embodiment, each search result card comprises two sides, and both of the two sides may be used for recording information and may be displayed to the user respectively at different times.

During specific implementation, a cascading stylesheet (CSS3) technique may be adopted. Two modules are arranged which respectively correspond to the first side and the second side; and the two modules are set to be oppositely arranged, and the two modules are set to have a turnover property. The turnover property may set a corresponding angle according to a turnover direction which is actually present. Taking a left-right turnover as an example, if it turns over from the first side to the second side counter-clockwise, while it turns over from the second side back to the first side clockwise, the turnover angle may be set as 180 degrees; and if it turns over from the first side to the second side counter-clockwise and turns over from the second side back to the first side also counter-clockwise, the turnover angle may be set as 360 degrees. That is, each search result card may be obtained by the following means:

setting each search result card, wherein each search result card is set to comprise a first side and a second side which are oppositely arranged, and setting turnover information about the first side and the second side so that the first side and the second side both have a turnover attribute, and setting the first side and the second side to turn over simultaneously.

In one embodiment, the turnover information comprises a turnover angle, wherein turnover angles of the first side and the second side are both set as 180 degrees so that a first direction and a second direction are opposite; or, the turnover angles of the first side and the second side are both set as 360 degrees so that the first direction and the second direction are the same, the first direction being a turnover direction turning over from the first side to the second side, and the second aspect being a turnover direction turning over from the second side to the first side.

In another embodiment, the turnover information comprises a turnover speed, wherein a first speed and a second speed are set as the same or different, the first speed being a turnover speed turning over from the first side to the second side, and the second speed being a turnover speed turning over from the second side to the first side.

S12: the mobile terminal displays the first side of the at least one search result card to the user.

After the search result card is obtained, one of the sides thereof may be displayed to the user for the user to view.

S13: the mobile terminal determines that the user needs to turn over a first search result card, the first search result card being a search result card selected by the user from the at least one search result card.

In the related art, when the user wants to view more information about a certain search result card, he/she may click on a link in the search result card to enter another page.

However, in this embodiment, when the user is viewing a certain search result card, assuming that the search result card needing to be viewed is referred to as a first search result card, and thus if more information on the first search result card needs to be learnt, the first search result card may be triggered to turn over, so that information from the other side of the first search result card is provided to the user.

Optionally, a hotspot region may be preset in each side of each search result card, and when the user clicks on the hotspot region, it indicates that a corresponding search result card needs to be turned over.

S14: the mobile terminal turns over the first search result card to display the second side of the first search result card to the user.

After it is determined that the user needs to turn over the first search result card, a turnover operation may be performed on the first search result card.

A rotational axis employed during turnover may be a central axis in a left-right direction or a central axis in an up-down direction.

In addition, optionally, link information may also be recorded in a non-hotspot region, and when the user clicks on the link information, a page indicated by the link information may be jumped to, rather than the card being turned over, so as to acquire more information in the page indicated by the link information.

Optionally, the link information is recorded in a non-hotspot region on the first side and/or the second side of the first search result card.

By means of recording information on both sides of the search result card, the user may acquire more information with respect to single-side display by turning over the search result card, and therefore, this embodiment may provide the resource utilization rate and improve user experience.

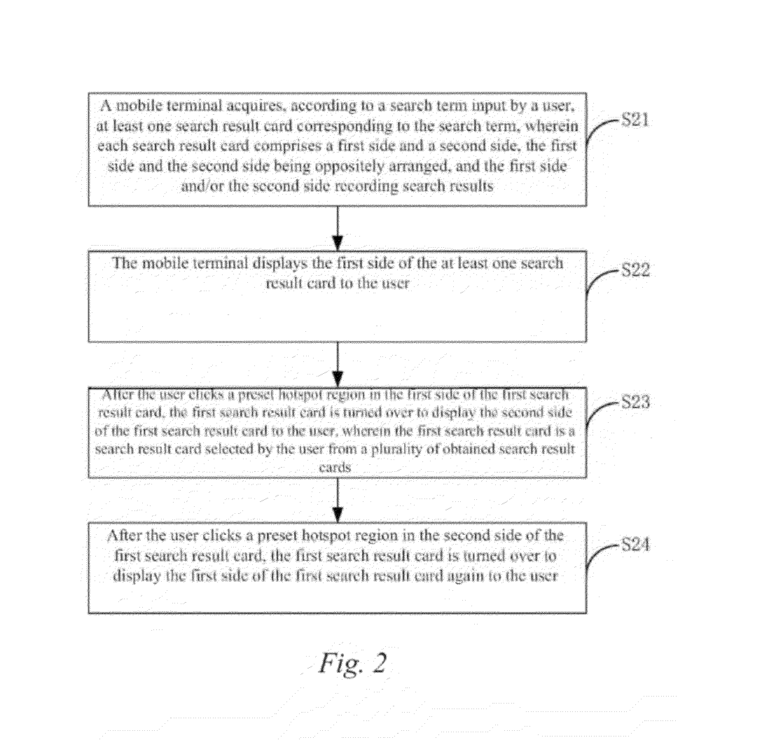

FIG. 2 is a schematic flowchart of a method for providing search content proposed by another embodiment of the present invention, comprising:

S21: a mobile terminal acquires, according to a search term input by a user, at least one search result card corresponding to the search term, wherein each search result card comprises a first side and a second side, the first side and the second side being oppositely arranged, and the first side and/or the second side recording search results.

For example, when searching for “fresh flowers”, the terminal will display a search result card containing “fresh flowers” to the user.

In the related art, each search result card is displayed on a single side in the form of a card in a mobile terminal, and a user may click to enter a selected search result card when needing to view more content.

In this embodiment, each search result card comprises two sides, and both of the two sides may be used for recording information and may be displayed to the user respectively at different times.

S22: the mobile terminal displays the first side of the at least one search result card to the user.

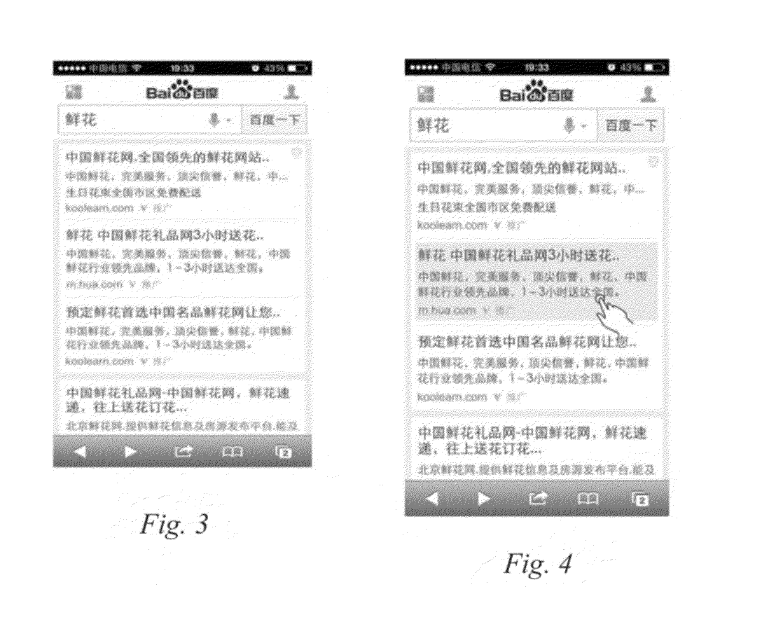

For example, with reference to FIG. 3, when searching for “fresh flowers”, a plurality of search result cards will be obtained, and during display, one side of the search result card is displayed.

S23: after the user clicks on a preset hotspot region in the first side of the first search result card, the first search result card is turned over to display the second side of the first search result card to the user, wherein the first search result card is a search result card selected by the user from a plurality of obtained search result cards.

With reference to FIG. 4, taking the case where the first search result card selected by the user is the first displayed search result card as an example, when the user clicks on the hotspot region of the first search result card, the turnover of the first search result card may be triggered.

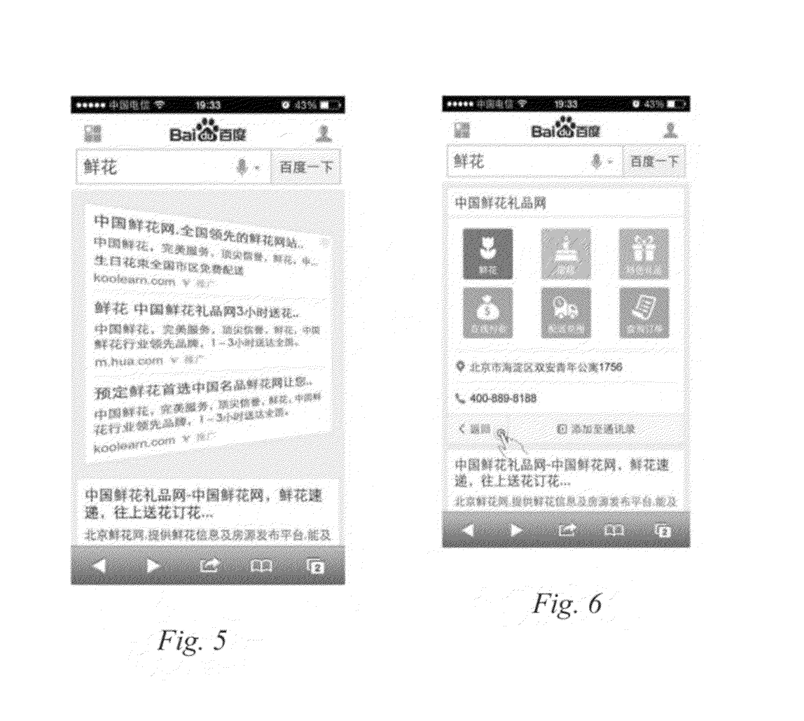

During turnover, the first side-an intermediate state-the second side may be presented in sequence, with reference to FIGS. 4, 5 and 6 for a series of visually coherent dynamic effects that “after clicking, stereoscopically presenting from the front side of the card, to a turnover intermediate state, and then to a back side”, etc.

It should be noted that the case where the search results are advertisements is taken as an example in the accompanying drawings, and it can be understood that with regard to the advertisements, three pieces of content may be contained on one search result card, and therefore, these three pieces of content will turn over together during turnover. With regard to other search results, for example, only one piece of content is contained on one search result card, then the one piece of content will turn over during turnover.

S24: after the user clicks on a preset hotspot region in the second side of the first search result card, the first search result card is turned over to display the first side of the first search result card again to the user.

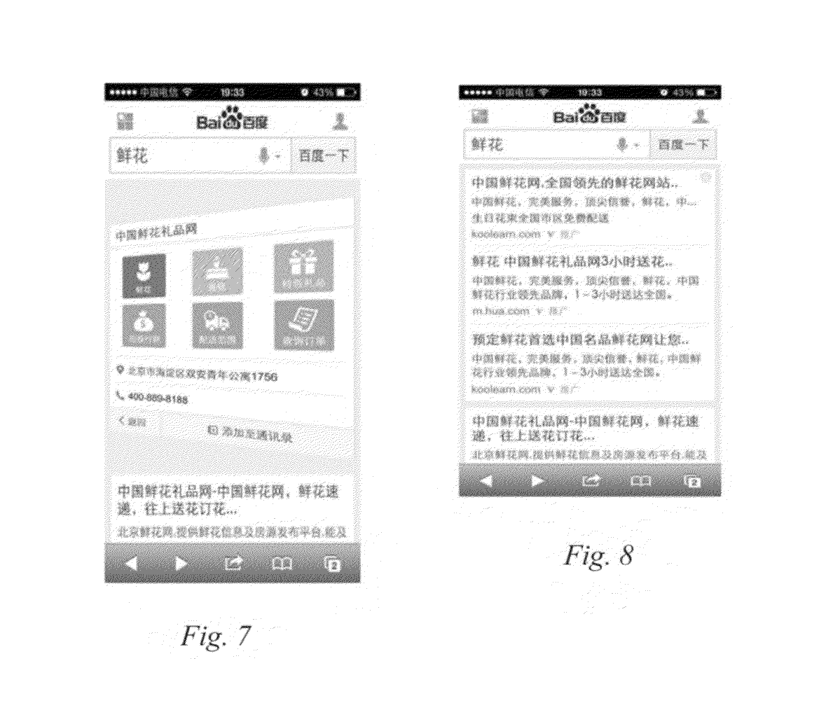

For example, with reference to FIGS. 7 and 8, the first search result card turns over again from the second side to display the first side.

In this embodiment, the two sides of the search result card may both be utilized by means of turning over the search result card. For example, with regard to the search result card of an advertisement, an advertisement title description may be recorded in one side of the search result card, and a landing page of advertisers may be recorded in the other side. Alternatively, an additional new concept of the advertisement is recorded in one side of the search result card, e.g., a map, and an instant Baidu map product is recorded on the other side.

In this embodiment, confidence is recorded on both of the two sides of the search result card by turning over the search result card; thus, the resource utilization rate may be improved, and more content may be acquired through browsing without jumping, which may shorten the distance between a user, a search service provider (such as Baidu) and a search content provider (such as an advertiser). The utilization of the back side of the card will greatly decrease the user churn rate, so that the user feeling is in fact a series of experiences completed at the search result card throughout, and will not jump to a variety of landing pages or jump to other pages, thereby improving overall user experience consistency.

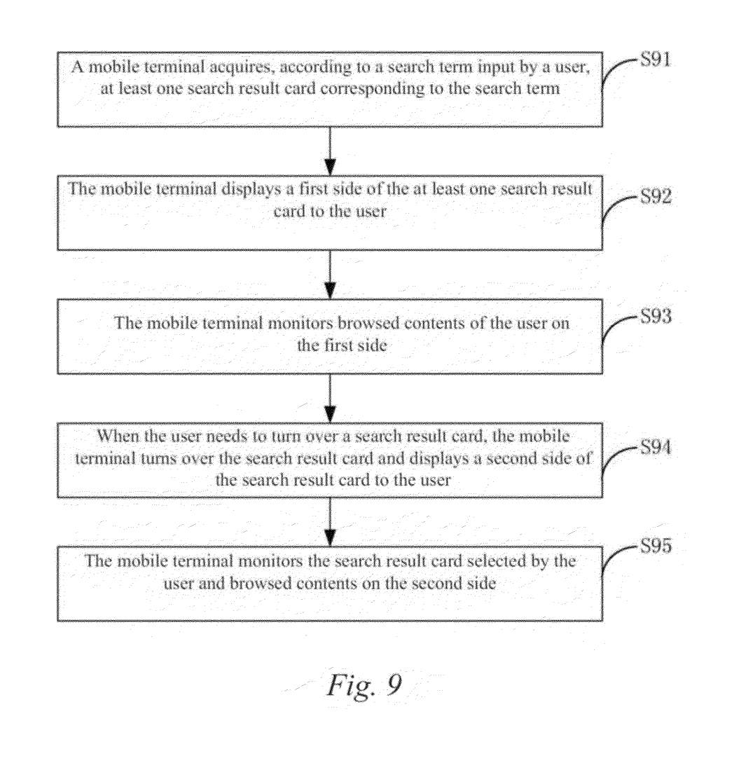

FIG. 9 is a schematic flowchart of a method for providing a search result proposed by another embodiment of the present invention, the method comprising:

S91: a mobile terminal acquires, according to a search term input by a user, at least one search result card corresponding to the search term.

S92: the mobile terminal displays a first side of the at least one search result card to the user.

Reference can be made to S11 and S12 for S91 and S92, and the details are not described herein again.

S93: the mobile terminal monitors content browsed by the user on the first side.

The mobile terminal may monitor user behavior in the background and take the user behavior as a data basis for subsequent processing. For example, which advertisements are browsed by the user is monitored in the background, and analytical data is provided to an advertiser; thus, the advertiser may optimize advertisement delivery according to these data.

S94: when the user needs to turn over a search result card, the mobile terminal turns over the search result card and displays a second side of the search result card to the user.

The specific implementation of turnover may refer to the above-mentioned embodiments, and the details are not described herein again.

S95: the mobile terminal monitors the search result card selected by the user and browsed contents on the second side.

Similarly, by monitoring user behavior, strong support may be provided for subsequent processing.

By recording information in the first side and the second side of the search result card, this embodiment may put user browsing behavior back onto the search result card and may monitor user behavior more conveniently, thereby providing strong support for subsequent processing via monitoring.

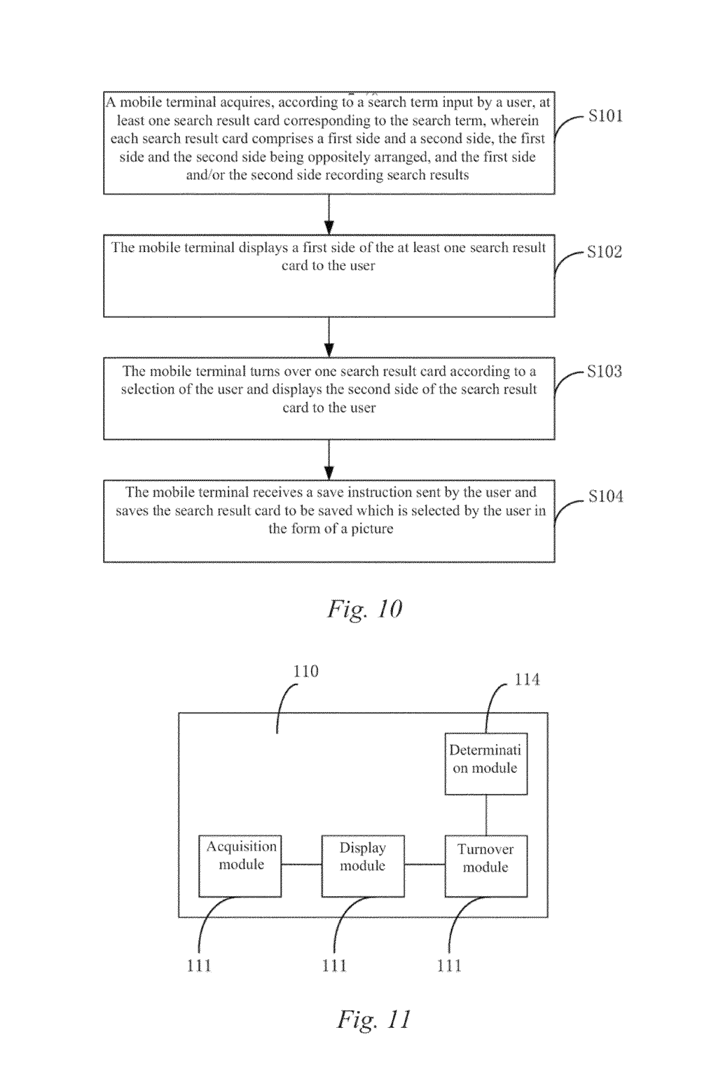

FIG. 10 is a schematic flowchart of a method for providing a search result proposed by another embodiment of the present invention, the method comprising:

S101: a mobile terminal acquires, according to a search term input by a user, at least one search result card corresponding to the search term, wherein each search result card comprises a first side and a second side, the first side and the second side being oppositely arranged, and the first side and/or the second side recording search results.

S102: the mobile terminal displays the first side of the at least one search result card to the user.

Reference can be made to S11 and S12 for S101 and S102, and the details are not described herein again.

S103: the mobile terminal turns over one search result card according to a selection of the user and displays the second side of the search result card to the user.

S104: the mobile terminal receives a save instruction sent by the user and saves the search result card to be saved which is selected by the user in the form of a picture.

For example, after browsing the first side and the second side of a search result card, if the search result card needs to be saved, the user clicks a preset save button, that is to say, sends a save instruction to the mobile terminal, and after receiving the save instruction, the mobile terminal may save the search result card.

On the basis of the above-mentioned embodiments, this embodiment may further implement a save operation so as to facilitate the user in finding corresponding information during subsequent use. In addition, by introducing the double-side search result card, an advertiser may be regarded as a “person”, wherein the card is a name card of the advertiser. On the front side of the card is various brief information about the advertiser and on the back side are his/her “address” and “contact number”, and this “name card” may even be saved in the user's mobile phone, and these all facilitate the user's use and improve user experience.

FIG. 11 is a structural schematic diagram of an apparatus for providing a search result proposed by another embodiment of the present invention. The apparatus 110 comprises an acquisition module 111, a display module 112, a determination module 113 and a turnover module 114.

The acquisition module 111 is for acquiring, according to a search term input by a user, at least one search result card corresponding to the search term, wherein each search result card comprises a first side and a second side, the first side and the second side being oppositely arranged, and the first side and/or the second side recording search results;

wherein the apparatus may specifically be a mobile terminal, and the mobile terminal may refer to a mobile phone, or a tablet computer, etc.

The apparatus may acquire corresponding search results from a server and display same to the user.

For example, when searching for “fresh flowers”, the mobile terminal will display a search result card containing “fresh flowers” to the user.

In the related art, each search result is displayed on a single side in the form of a card in a mobile terminal, and the user may click to enter a selected search result card when needing to view more content.

In this embodiment, each search result card comprises two sides, and both of the two sides may be used for recording information and may be displayed to the user respectively at different times.

During specific implementation, a cascading stylesheet (CSS3) technique may be adopted. Two modules are arranged which respectively correspond to the first side and the second side; and the two modules are set to be oppositely arranged, and the two modules are set to have a turnover property. The turnover property may set a corresponding angle according to a turnover direction which is actually present. Taking a left-right turnover as an example, if it turns over from the first side to the second side counter-clockwise, while it turns over from the second side back to the first side clockwise, the turnover angle may be set as 180 degrees; and if it turns over from the first side to the second side counter-clockwise and turns over from the second side back to the first side also counter-clockwise, the turnover angle may be set as 360 degrees. That is, each search result card may be obtained by the following means:

setting each search result card, wherein each search result card is set to comprise a first side and a second side which are oppositely arranged, and setting turnover information about the first side and the second side so that the first side and the second side both have a turnover attribute, and setting the first side and the second side to turn over simultaneously.

In one embodiment, the turnover information comprises a turnover angle, wherein turnover angles of the first side and the second side are both set as 180 degrees so that a first direction and a second direction are opposite; or, the turnover angles of the first side and the second side are both set as 360 degrees so that the first direction and the second direction are the same, the first direction being a turnover direction turning over from the first side to the second side, and the second aspect being a turnover direction turning over from the second side to the first side.

In another embodiment, the turnover information comprises a turnover speed, wherein a first speed and a second speed are set as the same or different, the first speed being a turnover speed turning over from the first side to the second side, and the second speed being a turnover speed turning over from the second side to the first side.

The display module 112 is used for displaying the first side of the at least one search result card to the user;

wherein after the search result card is obtained, one of the sides thereof may be displayed to the user for the user to view.

For example, with reference to FIG. 3, when searching for “fresh flowers”, a plurality of search result cards will be obtained, and during display, one side of the search result card is displayed.

The determination module 113 is for determining that the user needs to turn over a first search result card, the first search result card being a search result card selected by the user from the at least one search result card;

wherein in the related art, when the user wants to view more information about a certain search result card, he/she may click on a link in the search result card to enter another page.

However, in this embodiment, when the user is viewing a certain search result card, assuming that the search result card needing to be viewed is referred to as a first search result card, and thus if more information on the first search result card needs to be learnt, the first search result card may be triggered to turn over, so that information from the other side of the first search result card is provided to the user.

Referring to FIG. 4, taking the case where the first search result card selected by the user is the first displayed search result card as an example, when the user clicks on the hotspot region of the first search result card, the turnover of the first search result card may be triggered.

During turnover, the first side-an intermediate state-the second side may be presented in sequence, with reference to FIGS. 4, 5 and 6 for a series of visually coherent dynamic effects that “after clicking, stereoscopically presenting from the front side of the card, to a turnover intermediate state, and then to a back side”, etc.

It should be noted that the case where the search results are advertisements is taken as an example in the accompanying drawings, and it can be understood that with regard to the advertisements, three pieces of content may be contained on one search result card, and therefore, these three pieces of content will turn over together during turnover. With regard to other search results, for example, only one piece of content is contained on one search result card, then the one piece of content will turn over during turnover.

The turnover module 114 is used for turning over the first search result card to display the second side of the first search result card to the user,

wherein after it is determined that the user needs to turn over the first search result card, a turnover operation may be performed on the first search result card.

In one embodiment, the determination module 113 is further used for determining again that the user needs to turn over the first search result card; and

the turnover module 114 is further used for turning over the first search result card again to display the first side of the first search result card again to the user.

For example, with reference to FIGS. 7 and 8, the first search result card turns over again from the second side to display the first side.

In one embodiment, the determination module 113 is specifically used for:

determining that the user needs to turn over the first search result card when a region clicked on by the user is located in a preset hotspot region.

In one embodiment, in the first search result card, a preset hotspot region on the first side is the same as or different from a preset hotspot region on the second side.

In one embodiment, the turnover module 114 is specifically used for:

turning over the first search result card left and right taking a central axis of the first search result card in a left-right direction as a rotational axis; or turning over the first search result card up and down taking a central axis of the first search result card in an up-down direction as a rotational axis.

In this embodiment, the two sides of the search result card may both be utilized by means of turning over the search result card. For example, with regard to the search result card of an advertisement, an advertisement title description may be recorded in one side of the search result card, and a landing page of advertisers may be recorded in the other side. Alternatively, an additional new concept of the advertisement is recorded in one side of the search result card, e.g., a map, and an instant Baidu map product is recorded on the other side.

In this embodiment, confidence is recorded on both of the two sides of the search result card by turning over the search result card; thus, the resource utilization rate may be improved, and more content may be acquired through browsing without jumping, which may shorten the distance between a user, a search service provider (such as Baidu) and a search content provider (such as an advertiser). The utilization of the back side of the card will greatly decrease the user churn rate, so that the user feeling is in fact a series of experiences completed at the search result card throughout, and will not jump to a variety of landing pages or jump to other pages, thereby improving overall user experience consistency.

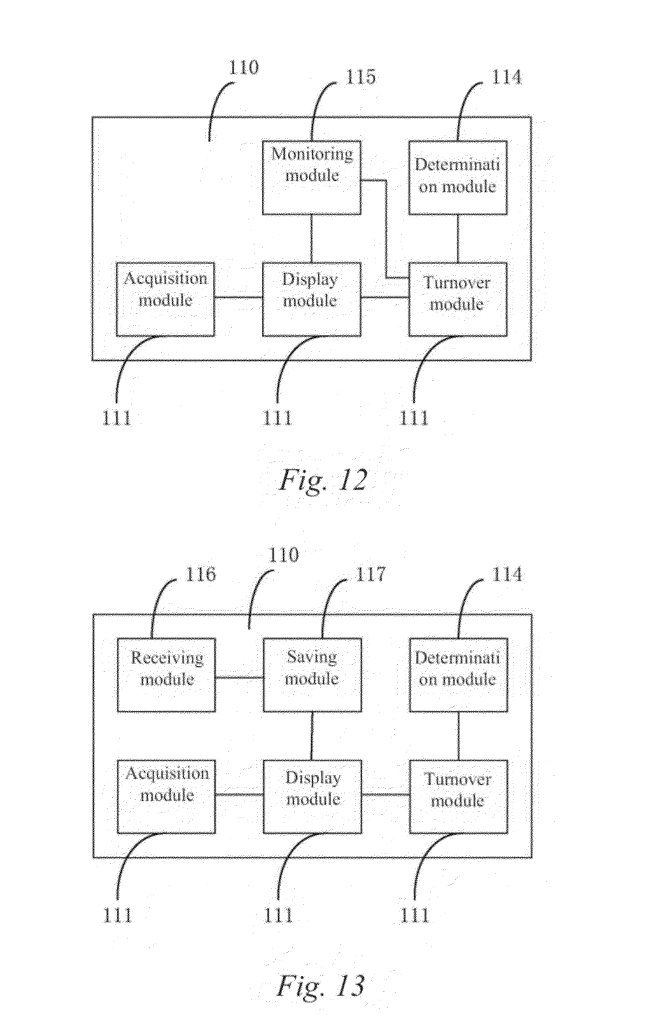

FIG. 12 is a structural schematic diagram of an apparatus for providing a search result proposed by another embodiment of the present invention. On the basis of the embodiment illustrated in FIG. 11, the apparatus further comprises a monitoring module 115.

The monitoring module 115 is used for monitoring contents of the first side of the at least one search result card browsed by the user and contents of the second side of the at least one search result card browsed by the user,

wherein the mobile terminal may monitor user behavior in the background and take the user behavior as a data basis for subsequent processing. For example, which advertisements are browsed by the user is monitored in the background, and analytical data is provided to an advertiser; thus, the advertiser may optimize advertisement delivery according to these data.

By recording information in the first side and the second side of the search result card, this embodiment may put user browsing behavior back onto the search result card and may monitor user behavior more conveniently, thereby providing strong support for subsequent processing via monitoring.

FIG. 13 is a structural schematic diagram of an apparatus for providing a search result proposed by another embodiment of the present invention. On the basis of the embodiment illustrated in FIG. 11, the apparatus further comprises a receiving module 116 and a saving module 117.

The receiving module 116 is used for receiving a save command input by the user, the save command being used for saving a second search result card, the second search result card being selected by the user from the at least one search result card, and the second search result card being the same as or different from the first search result card; and the saving module 117 is used for saving the second search result card in the form of a picture in a mobile terminal of the user.

For example, after browsing the first side and the second side of a search result card, if the search result card needs to be saved, the user clicks a preset save button, that is to say, sends a save instruction to the mobile terminal, and after receiving the save instruction, the mobile terminal may save the search result card.

On the basis of the above-mentioned embodiments, this embodiment may further implement a save operation so as to facilitate the user in finding corresponding information during subsequent use. In addition, by introducing the double-side search result card, an advertiser may be regarded as a “person”, wherein the card is a name card of the advertiser. On the front side of the card is various brief information about the advertiser and on the back side are his/her “address” and “contact number”, and this “name card” may even be saved in the user's mobile phone, and these all facilitate the user's use and improve user experience.

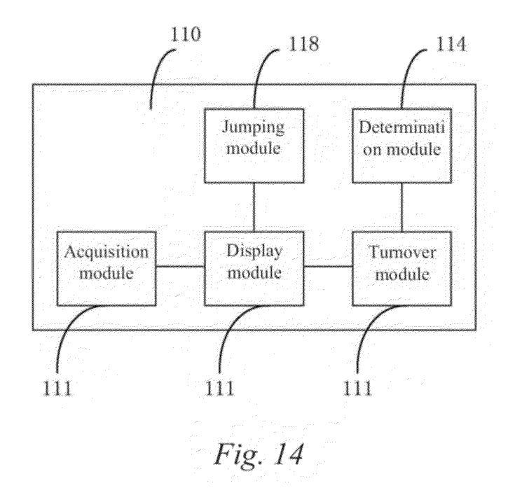

FIG. 14 is a structural schematic diagram of an apparatus for providing a search result proposed by another embodiment of the present invention. On the basis of the embodiment illustrated in FIG. 11, the apparatus further comprises a jumping module 118. In this embodiment, the first search result card further records link information, the link information being located in a non-hotspot region, and the jumping module 118 is used for jumping to a page indicated by the link information when the user clicks on the link information.

The link information is recorded in a non-hotspot region on the first side and/or the second side of the first search result card.

On the basis of the above-mentioned embodiments, this embodiment may further perform jumping and may acquire more information.

An embodiment of the present invention further provides a mobile terminal, the mobile terminal comprising: a housing, a processor, a memory, a circuit board and a power supply circuit, wherein the circuit board is mounted inside a space enclosed by the housing, and the processor and the memory are disposed on the circuit board; the power supply circuit is used for supplying power to various circuits or devices of the mobile terminal; the memory is used for storing executable program codes; and the processor operates programs corresponding to the executable program codes by reading the executable program codes stored in the memory for carrying out the following steps:

S11′: a mobile terminal acquires, according to a search term input by a user, at least one search result card corresponding to the search term, wherein each search result card comprises a first side and a second side, the first side and the second side being oppositely arranged, and the first side and/or the second side recording search results.

The mobile terminal may refer to a mobile phone, or a tablet computer, etc.

The mobile terminal may acquire corresponding search results from a server and display same to the user.

For example, when searching for “fresh flowers”, the mobile terminal will display a search result card containing “fresh flowers” to the user.

In the related art, each search result is displayed on a single side in the form of a card in a mobile terminal, and the user may click to enter a selected search result card when needing to view more content.

In this embodiment, each search result card comprises two sides, and both of the two sides may be used for recording information and may be displayed to the user respectively at different times.

During specific implementation, a cascading stylesheet (CSS3) technique may be adopted. Two modules are arranged which respectively correspond to the first side and the second side; and the two modules are set to be oppositely arranged, and the two modules are set to have a turnover property. The turnover property may set a corresponding angle according to a turnover direction which is actually present. Taking a left-right turnover as an example, if it turns over from the first side to the second side counter-clockwise, while it turns over from the second side back to the first side clockwise, the turnover angle may be set as 180 degrees; and if it turns over from the first side to the second side counter-clockwise and turns over from the second side back to the first side also counter-clockwise, the turnover angle may be set as 360 degrees. That is, each search result card may be obtained by the following means:

setting each search result card, wherein each search result card is set to comprise a first side and a second side which are oppositely arranged, and setting turnover information about the first side and the second side so that the first side and the second side both have a turnover attribute, and setting the first side and the second side to turn over simultaneously.

In one embodiment, the turnover information comprises a turnover angle, wherein turnover angles of the first side and the second side are both set as 180 degrees so that a first direction and a second direction are opposite; or, the turnover angles of the first side and the second side are both set as 360 degrees so that the first direction and the second direction are the same, the first direction being a turnover direction turning over from the first side to the second side, and the second aspect being a turnover direction turning over from the second side to the first side.

In another embodiment, the turnover information comprises a turnover speed, wherein a first speed and a second speed are set as the same or different, the first speed being a turnover speed turning over from the first side to the second side, and the second speed being a turnover speed turning over from the second side to the first side.

S12′: the mobile terminal displays the first side of the at least one search result card to the user.

After the search result card is obtained, one of the sides thereof may be displayed to the user for the user to view.

S13′: the mobile terminal determines that the user needs to turn over a first search result card, the first search result card being a search result card selected by the user from the at least one search result card.

In the related art, when the user wants to view more information about a certain search result card, he/she may click on a link in the search result card to enter another page.

However, in this embodiment, when the user is viewing a certain search result card, assuming that the search result card needing to be viewed is referred to as a first search result card, and thus if more information on the first search result card needs to be learnt, the first search result card may be triggered to turn over, so that information from the other side of the first search result card is provided to the user.

Optionally, a hotspot region may be preset in each side of each search result card, and when the user clicks on the hotspot region, it indicates that a corresponding search result card needs to be turned over.

S14′: the mobile terminal turns over the first search result card to display the second side of the first search result card to the user.

After it is determined that the user needs to turn over the first search result card, a turnover operation may be performed on the first search result card.

A rotational axis employed during turnover may be a central axis in a left-right direction or a central axis in an up-down direction.

In addition, optionally, link information may also be recorded in a non-hotspot region, and when the user clicks on the link information, a page indicated by the link information may be jumped to, rather than the card being turned over, so as to acquire more information in the page indicated by the link information.

Optionally, the link information is recorded in a non-hotspot region on the first side and/or the second side of the first search result card.

By means of recording information in both sides of the search result card, the user may acquire more information with respect to single-side display by turning over the search result card, and therefore this embodiment may provide the resource utilization rate and improve user experience.

In another embodiment, the processor operates programs corresponding to executable program codes by reading the executable program codes stored in the memory for carrying out the following steps:

In another embodiment, the processor operates programs corresponding to executable program codes by reading the executable program codes stored in the memory for carrying out the following steps:

S21′: a mobile terminal acquires, according to a search term input by a user, at least one search result card corresponding to the search term, wherein each search result card comprises a first side and a second side, the first side and the second side being oppositely arranged, and the first side and/or the second side recording search results.

For example, when searching for “fresh flowers”, the terminal will display a search result card containing “fresh flowers” to the user.

In the related art, each search result card is displayed on a single side in the form of a card in a mobile terminal, and a user may click to enter a selected search result card when needing to view more contents.

In this embodiment, each search result card comprises two sides, and both of the two sides may be used for recording information and may be displayed to the user respectively at different times.

S22′: the mobile terminal displays the first side of the at least one search result card to the user.

For example, with reference to FIG. 3, when searching for “fresh flowers”, a plurality of search result cards will be obtained, and during display, one side of the search result card is displayed.

S23′: after the user clicks on a preset hotspot region in the first side of the first search result card, the first search result card is turned over to display the second side of the first search result card to the user, wherein the first search result card is a search result card selected by the user from a plurality of obtained search result cards.

Referring to FIG. 4, taking the case where the first search result card selected by the user is the first displayed search result card as an example, when the user clicks on the hotspot region of the first search result card, the turnover of the first search result card may be triggered.

During turnover, the first side-an intermediate state-the second side may be presented in sequence, with reference to FIGS. 4, 5 and 6 for a series of visually coherent dynamic effects that “after clicking, stereoscopically presenting from the front side of the card, to a turnover intermediate state, and then to a back side”, etc.

It should be noted that the case where the search results are advertisements is taken as an example in the accompanying drawings, and it can be understood that with regard to the advertisements, three pieces of content may be contained on one search result card, and therefore, these three pieces of content will turn over together during turnover. With regard to other search results, for example, only one piece of content is contained on one search result card, then the one piece of content will turn over during turnover.

S24′: after the user clicks on a preset hotspot region in the second side of the first search result card, the first search result card is turned over to display the first side of the first search result card again to the user.

For example, with reference to FIGS. 7 and 8, the first search result card turns over again from the second side to display the first side.

In this embodiment, the two sides of the search result card may both be utilized by means of turning over the search result card. For example, with regard to the search result card of an advertisement, an advertisement title description may be recorded in one side of the search result card, and a landing page of advertisers may be recorded in the other side. Alternatively, an additional new concept of the advertisement is recorded in one side of the search result card, e.g., a map, and an instant Baidu map product is recorded on the other side.

In this embodiment, confidence is recorded on both of the two sides of the search result card by turning over the search result card; thus, the resource utilization rate may be improved, and more content may be acquired through browsing without jumping, which may shorten the distance between a user, a search service provider (such as Baidu) and a search content provider (such as an advertiser). The utilization of the back side of the card will greatly decrease the user churn rate, so that the user feeling is in fact a series of experiences completed at the search result card throughout, and will not jump to a variety of landing pages or jump to other pages, thereby improving overall user experience consistency.

In another embodiment, the processor operates programs corresponding to executable program codes by reading the executable program codes stored in the memory for carrying out the following steps:

S91′: a mobile terminal acquires, according to a search term input by a user, at least one search result card corresponding to the search term.

S92′: the mobile terminal displays a first side of the at least one search result card to the user.

Reference can be made to S11′ and S12′ for S91′ and S92′, and the details are not described herein again.

S93′: the mobile terminal monitors content browsed by the user on the first side.

The mobile terminal may monitor user behavior in the background and take the user behavior as a data basis for subsequent processing. For example, which advertisements are browsed by the user is monitored in the background, and analytical data is provided to an advertiser; thus, the advertiser may optimize advertisement delivery according to these data.

S94′: when the user needs to turn over a search result card, the mobile terminal turns over the search result card and displays a second side of the search result card to the user.

The specific implementation of turnover may also refer to the above-mentioned embodiments, and the details are not described herein again.

S95′: the mobile terminal monitors the search result card selected by the user and browsed contents on the second side.

Similarly, by monitoring the user behavior, strong support may be provided for subsequent processing.

By recording information in the first side and the second side of the search result card, this embodiment may put user browsing behavior back onto the search result card and may monitor user behavior more conveniently, thereby providing strong support for subsequent processing via monitoring.

In another embodiment, the processor operates programs corresponding to executable program codes by reading the executable program codes stored in the memory for carrying out the following steps:

S101′: a mobile terminal acquires, according to a search term input by a user, at least one search result card corresponding to the search term, wherein each search result card comprises a first side and a second side, the first side and the second side being oppositely arranged, and the first side and/or the second side recording search results.

S102′: the mobile terminal displays the first side of the at least one search result card to the user.

Reference can be made to S11 and S12 for S101′ and S102′, and the details are not described herein again.

S103′: the mobile terminal turns over one search result card according to a selection of the user and displays the second side of the search result card to the user.

S104′: the mobile terminal receives a save instruction sent by the user and saves the search result card to be saved which is selected by the user in the form of a picture.

For example, after browsing the first side and the second side of a search result card, if the search result card needs to be saved, the user clicks on a preset save button, that is to say, sends a save instruction to the mobile terminal, and after receiving the save instruction, the mobile terminal may save the search result card.

On the basis of the above-mentioned embodiments, this embodiment may further implement a save operation so as to facilitate the user in finding corresponding information during subsequent use. In addition, by introducing the double-side search result card, an advertiser may be regarded as a “person”, wherein the card is a name card of the advertiser. On the front side of the card is various brief information about the advertiser and on the back side are his/her “address” and “contact number”, and this “name card” may even be saved in the user's mobile phone, and these all facilitate the user's use and improve user experience.

It should be noted that in the description of the present invention, the terms “first” and “second” are merely for description purposes, rather than being understood to indicate or imply relative importance. Furthermore, in the description of the present invention, unless otherwise specified, the meaning of “a plurality” is two or more than two.

Any process or method description in the flowchart or otherwise described herein may be understood to represent a module, segment or section comprising one or more codes of executable instructions used for implementing a particular logical function or process step, and the scope of the preferred embodiments of the present invention comprises further implementations, where functions may be carried out not according to the order shown or discussed, comprising according to a basically synchronous manner or an inverse order in accordance with involved functions, and this should be understood by those skilled in the art to which the embodiments of the present invention belong.

It should be understood that various parts of the present invention may be implemented by means of hardware, software, firmware or a combination thereof. In the embodiments above, a plurality of steps or methods may be implemented by means of software or firmware stored in a memory and executed by an appropriate instruction execution system. For example, if implemented by means of hardware, likewise in another embodiment, it can be implemented by means of any one or a combination of the following techniques commonly known in the art: a discrete logical circuit having a logical gate circuit used for implementing a logical function for a data signal, an application-specific integrated circuit having an appropriate combinational logical gate circuit, a programmable gate array (PGA), a field programmable gate array (FPGA), etc.

Those of ordinary skill in the art shall understand that the implementation of all or some of the steps carried in the above-mentioned embodiment methods may be achieved by instructing relevant hardware with a program. The program may be stored in a computer readable storage medium, and when executed, the program comprises one of the steps in the method embodiments or a combination thereof.

In addition, various functional units in various embodiments of the present invention may be integrated into a processing module, or each of the units may exist alone physically, or two or more than two units may be integrated into a module. The above-mentioned integrated module may be implemented in the form of hardware, and may also be implemented in the form of a software functional module. When implemented in the form of a software functional module and sold or used as an independent product, the integrated module may also be stored in a computer readable storage medium. The above-mentioned storage medium may be a read-only memory, a magnetic disk, or an optical disk, etc.

In the description of the specification, the description to the reference terms such as “one embodiment”, “some embodiments”, “an example”, “a specific example” or “some examples” is intended to mean that a particular feature, structure, material or characteristic described in connection with the embodiment or example is included in at least one embodiment or example of the present invention. In the present description, the illustrative expression of the above-mentioned terms does not necessarily refer to the same embodiment or example. Furthermore, the described particular feature, structure, material or characteristic may be combined in a suitable manner in any one or more embodiments or examples.

In the description of the present invention, it should be understood that orientation or location relationships indicated by the terms “central”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise”, “counter-clockwise”, “axial direction”, “radial direction”, “circumferential direction”, etc. are orientation or location relationships illustrated on the basis of the accompanying drawings, and are merely intended to facilitate the description of the present invention and simplify the description, rather than indicating or implying that the apparatus or element referred to must have a particular orientation and be constructed and operated in the specific orientation, and thus should not be understood as limitations to the present invention.

In the present invention, unless explicitly stipulated and defined otherwise, the terms “installation”, “connected”, “connection”, “fixing”, etc. should be understood broadly, for example, it may be a fixed connection, may also be a detachable connection, or be integrated into one; it may be a mechanical connection, and may also be an electrical connection; and it may be a direct connection, or may be an indirect connection by means of an intermediate medium, and may be an internal connectivity of two elements or an interaction relationship of two elements. For those of ordinary skill in the art, the specific meaning of the terms above in the present invention may be understood according to specific situations.

In the present invention, unless explicitly stipulated and defined otherwise, a first feature being “on” or “under” a second feature may mean that the first feature directly contacts the second feature, or the first and second features indirectly contact via an intermediate medium. In addition, the first feature being “on”, “over” and “above” the second feature may mean that the first feature is right above the second feature or above the second feature diagonally, or merely represent that the first feature has a higher horizontal height than that of the second feature. The first feature being “below”, “under” and “underneath” the second feature may mean that the first feature is right below the second feature or below the second feature diagonally, or merely represent that the first feature has a smaller horizontal height than that of the second feature.

Although the embodiments of the present invention have been shown and described above, it should be understood that the embodiments above are exemplary and shall not be understood as limitations to the present invention. Those of ordinary skill in the art may make changes, modifications, replacements and variations to the embodiments above within the scope of the present invention.

1-24. (canceled)

25. A method for providing a search result, comprising:
acquiring at least one search result card corresponding to a search term, each search result card comprising a first side and a second side being opposite the first side, at least one of the first side and the second side recording search results;
displaying the first side of the at least one search result card;
determining whether a first selected search result card from the at least one search result card needs to be turned over; and
turning over the first selected search result card to display the second side of the first selected search result card based upon said determining.

26. The method of claim 25, further comprising:
determining whether the first selected search result card needs to be turned over again; and
turning over the first selected search result card to display the first side of the first selected search result card based upon said determining whether the first selected search result card needs to be turned over again.

27. The method of claim 26, further comprising monitoring at least one of content of the first side of the first selected search result card that is browsed and content of the second side of the first selected search result card that is browsed.

28. The method of claim 25, wherein said determining comprises determining whether the first selected search result card needs to be turned over based upon activation of a preset hotspot region of the first selected search result card.

29. The method of claim 28, wherein said determining is based upon activation of a first preset hotspot region on the first side of the first selected search result card that is identical to a second preset hotspot region on the second side of the first selected search result card.

30. The method of claim 28, wherein said determining is based upon activation of a first preset hotspot region on the first side of the first selected search result card that is different from a second preset hotspot region on the second side of the first selected search result card.

31. The method of claim 25, further comprising:
receiving a save command input for saving a second selected search result card from the at least one search result card; and
saving the second selected search result card in the form of a picture in a mobile terminal.

32. The method of claim 31, wherein said receiving includes receiving the save command input for saving the second selected search result card that is identical to the first selected search result card.

33. The method of claim 31, wherein said receiving includes receiving the save command input for saving the second selected search result card that is different from the first selected search result card.

34. The method of claim 25, wherein said turning over the first selected search result card comprises at least one of:
turning over the first selected search result card left and right taking a central axis of the first search result card in a left-right direction as a rotational axis; and
turning over the first selected search result card up and down taking a central axis of the first search result card in an up-down direction as a rotational axis.

35. The method of claim 25, further comprising jumping to a page indicated by link information recorded by the first selected search result card and being located in a non-hotspot region of the first selected search result card in response to activation of the link information.

36. The method of claim 35, wherein the link information is recorded in at least one of a non-hotspot region on the first side of the first selected search result card and a non-hotspot region on the second side of the first selected search result card.

37. The method of claim 25, further comprising obtaining each of the at least one search result card by:
setting each of the at least one search result card to comprise the first and second sides;
setting turnover information about the first and second sides of each of the at least one search result card so that the first and second sides each have a turnover attribute; and
setting the first side and the second side of each of the at least one search result card to turn over simultaneously.

38. The method of claim 37, wherein said setting turnover information includes setting a turnover angle for a selected search result card.

39. The method of claim 38, wherein said setting the turnover angle for the selected search result card includes:
setting a first turnover angle for the first side of the selected search result card to 180 degrees, the first turnover angle being associated with a first turnover direction for turning the selected search result card over from the first side to the second side; and
setting a second turnover angle for the second side of the selected search result card to 180 degrees, the second turnover angle being opposite the first turnover angle and being associated with a second turnover direction for turning the selected search result card over from the second side to the first side.

40. The method of claim 38, wherein said setting the turnover angle for the selected search result card includes:
setting a first turnover angle for the first side of the selected search result card to 360 degrees, the first turnover angle being associated with a first turnover direction for turning the selected search result card over from the first side to the second side; and
setting a second turnover angle for the second side of the selected search result card to 360 degrees, the second turnover angle being identical to the first turnover angle and being associated with a second turnover direction for turning the selected search result card over from the second side to the first side.

41. The method of claim 40, wherein said setting turnover information includes setting a turnover speed for a selected search result card, the turnover speed including a first turnover speed for turning the selected search result card over from the first side to the second side and a second turnover speed for turning the selected search result card over from the second side to the first side, the first turnover speed and the second turnover speed being identical.

42. The method of claim 37, wherein said setting turnover information includes setting a turnover speed for a selected search result card, the turnover speed including a first turnover speed for turning the selected search result card over from the first side to the second side and a second turnover speed for turning the selected search result card over from the second side to the first side, the first turnover speed and the second turnover speed being different.

43. An apparatus for providing a search result, comprising:
an acquisition module for acquiring at least one search result card corresponding to a search term, each search result card comprising a first side and a second side being opposite the first side, at least one of the first side and the second side recording search results;
a display module for displaying the first side of the at least one search result card;
a determination module for determining whether a selected first search result card from the at least one search result card needs to be turned over; and
a turnover module for turning over the selected first search result card to display the second side of the selected first search result card based upon said determining.

44. A non-volatile computer storage medium including at least one program for providing a search result when implemented by a processor, comprising:
instruction for acquiring at least one search result card corresponding to a search term, each search result card comprising a first side and a second side being opposite the first side, at least one of the first side and the second side recording search results;
instruction for displaying the first side of the at least one search result card;
instruction for determining whether a selected first search result card from the at least one search result card needs to be turned over; and
instruction for turning over the selected first search result card to display the second side of the selected first search result card based upon said determining.
